(19) United States
(12) Patent Application Publication
(10) Pub. No.: US 2004/0018878 A1
(43) Pub. Date: Jan. 29, 2004

(54) Board game apparatus

(76) Inventor: Lawrence Silverman, Newtown Square, PA (US)

Correspondence Address: Robert S. Lipton, Esquire, Lipton, Weinberger & Husick, 201 North Jackson Street, P.O. Box 934, Media, PA, 19063, US

(21) Appl. No.: 10/201,875

(22) Filed: Jul. 25, 2002

(51) Int. Cl. A63F 13/00

(52) U.S. Cl. 463/46

(57) ABSTRACT

The invention is a game apparatus integrating board games with computer games. Game play information and data defining a board game playing surface are received by a client computer from a server computer over a computer network. The client computer displays game play information to a player and prints a playing surface of a board game. The game playing surface and game play information may be adjusted dynamically before play and during play to account for differing numbers, relationships, skill, knowledge and maturity of players, or other characteristics of the players, or in response to actions taken by the players during the game itself.

### BACKGROUND OF THE INVENTION

1. Field of the Invention

The invention is a board game apparatus providing an integrated board and computer game. The playing surface of the game, the game pieces and the instructions for play are printed or otherwise provided by a computer. The computer adjusts game play to account for the number and type of players, and differences in experience and ability among the players.

2. Related Art

Board games are a familiar form of entertainment and are produced in many types. Popular examples include chess, Trivial Pursuit™, Monopoly™ and Scrabble™. All board games include the element of a substantially flat game board. The game board embodies the rules and operations of play that define that particular game, and also serves the function of defining the boundaries of the game and providing a visual reminder of the status of game play.

All board games include the use of game pieces. Each player is assigned one or more game pieces. As used in this application, the term “game pieces” means all tokens or other objects that are to be placed on the game board or that are used or manipulated by the players as a part of game play. During game play, some or all of the game pieces are placed physically on the game board or are moved from one location to another on the game board according to the rules of the particular game. In chess, the chessmen comprise the game pieces. In Monopoly™, the game pieces are the tokens, houses and hotels, property cards and Monopoly™ money. In Scrabble™, the game pieces are blocks marked with the letters of the alphabet. In a board game, the placing, movement or manipulation of game pieces may be determined by chance, by the skill of the player or by a combination of skill and chance.

An advantage of board games is the cooperative nature of such games. Board game play requires interaction between live players who in general are physically in the same location. Board games provide an opportunity for a family or other group of persons to play together and to interact socially while doing so. The board games offer the further advantage of low cost.

The elements of a board game typically include: (1) chance, (2) skill, (3) the field of play or “world,” and (4) the identity of the player. The identity of the player in the game can be as simple as a colored game piece or as complex as a role-playing character.

Prior art board games have the disadvantage that each game is inflexible. The reason for the inflexibility is the fixed physical design of the game board. The rules of the game are incorporated into and are in part defined by the design of the game board. Incorporation of the game rules into the design of the game board means that the varieties of games that can be played on a single game board are limited. Generally, a game board apparatus is designed for the play of only one game.

Computer games conversely offer great flexibility because a computer can be programmed in an infinite variety of ways to accommodate an infinite variety of games. A disadvantage of a computer as a game medium is the high cost of the computer and of the games themselves. Generally, only one person at a time can play the computer game. A computer means a microprocessor-based machine operated by a human user, and includes such devices and systems as PCs, PDAs, smart phones, and fixed format game boxes such as PS2 or Xbox.

Computer games have the further disadvantage that such games generally are isolating activities, played by a solitary player. The player interacts with the computer, or, at best, with other players at remote locations through the computer. Live, personal interaction with other people is generally missing from computer games.

The present invention combines the flexibility offered by computers as a game vehicle with the low cost and personal interaction inherent in a board game.

### SUMMARY OF THE INVENTION

The present invention is an apparatus for providing an integrated board game and computer game. Information defining the playing surface of a game board is transmitted to a game player's client computer from a server computer over a computer network, such as the Internet. A playing surface is printed by a computer printer communicating with the client computer using the information supplied by the server computer. Alternatively, the playing surface may be electronically displayed to the player by a computer monitor, television set or other electronic display. Information defining game pieces may be transmitted from the server computer to the client computer to be displayed and/or printed by a computer printer.

In the alternative of a printed playing surface, the playing surface is inserted into a game board. Game play proceeds as in a conventional board game and according to the rules of the game. Physical (rather than electronic) game pieces are moved on the game board and playing surface by a player. Game pieces printed by a computer printer may be inserted into a game piece holder to simplify manipulation of the game piece by the player.

Before and during game play, playing instructions are received by the client computer from the server computer and displayed to or printed out for the game players. The playing instructions are adjusted to tailor the challenges presented by the game to the ability of each player. The game may continue to interact with the players through the Internet for the purpose of linking geographically separated players, or for the purpose of modifying the game itself through interaction with the players. The playing instructions can be dynamic, that is, they can change during the course of the game in response to actions taken by the players.

### BRIEF DESCRIPTION OF THE DRAWINGS

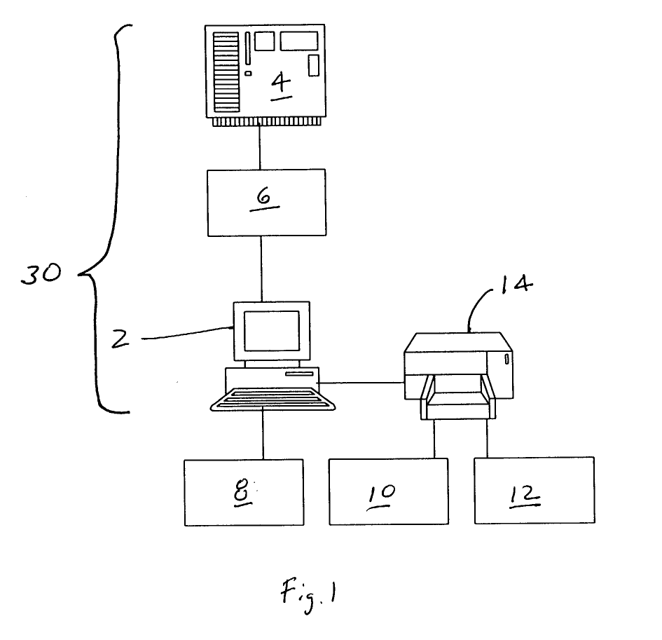

1. FIG. 1 is a block diagram of the present invention.

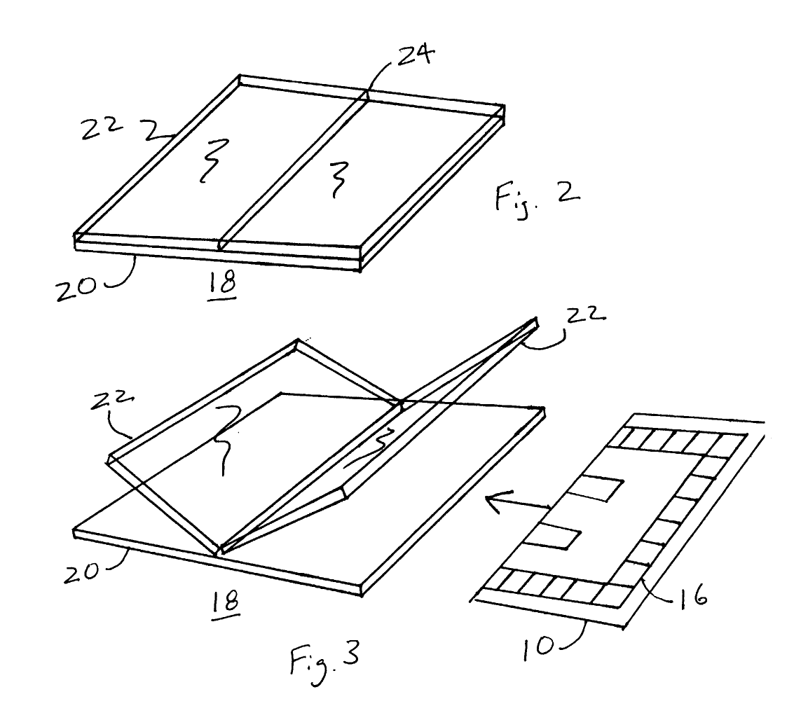

2. FIG. 2 is a perspective view of a game.

3. FIG. 3 is a game board receiving a playing surface.

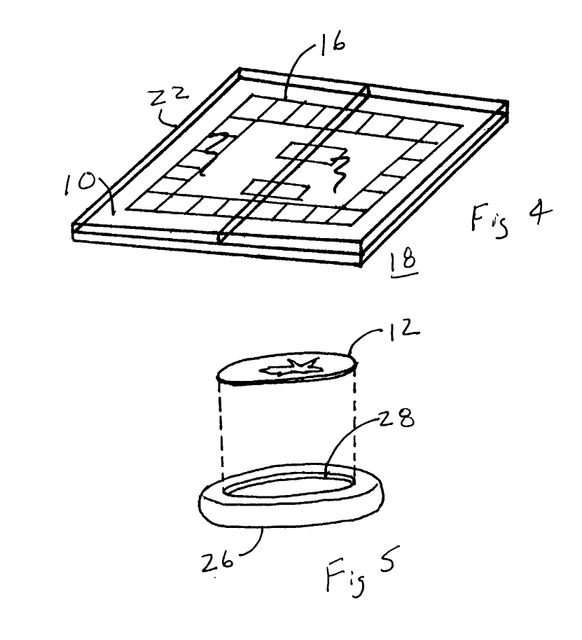

4. FIG. 4 is a game board with playing surface installed.

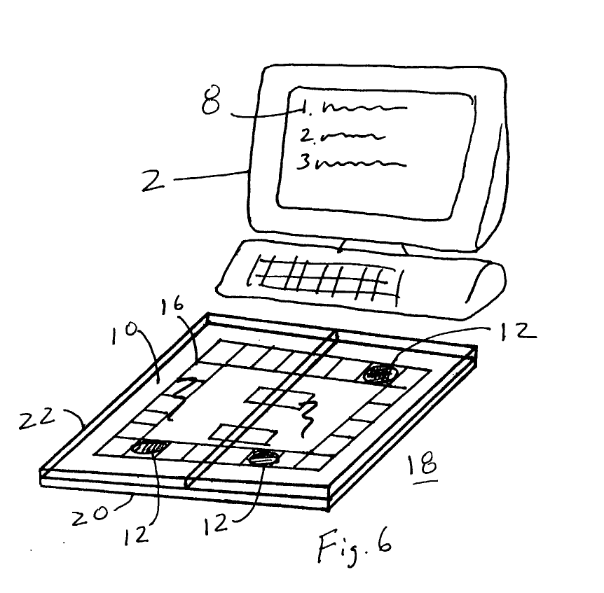

5. FIG. 5 is a game piece.

6. FIG. 6 illustrates a game in progress.

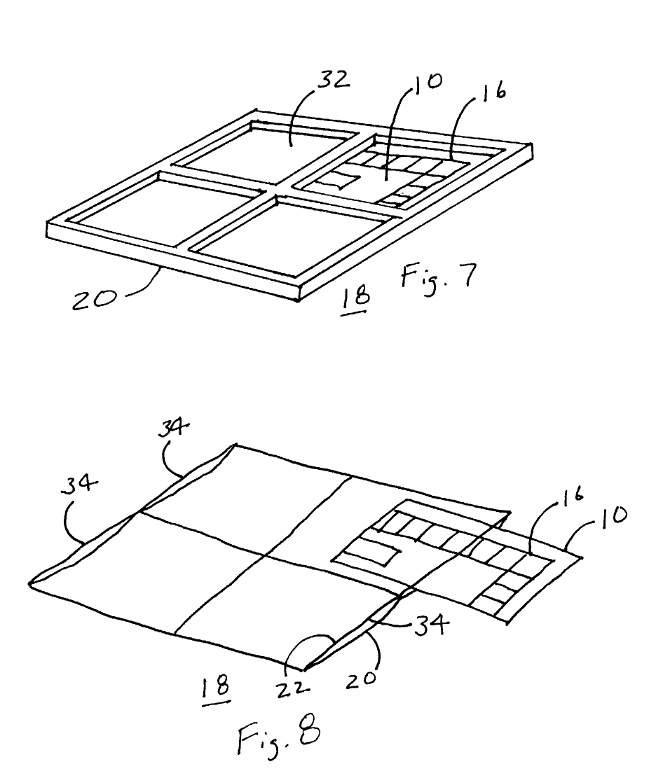

7. FIG. 7 is another embodiment of the game board.

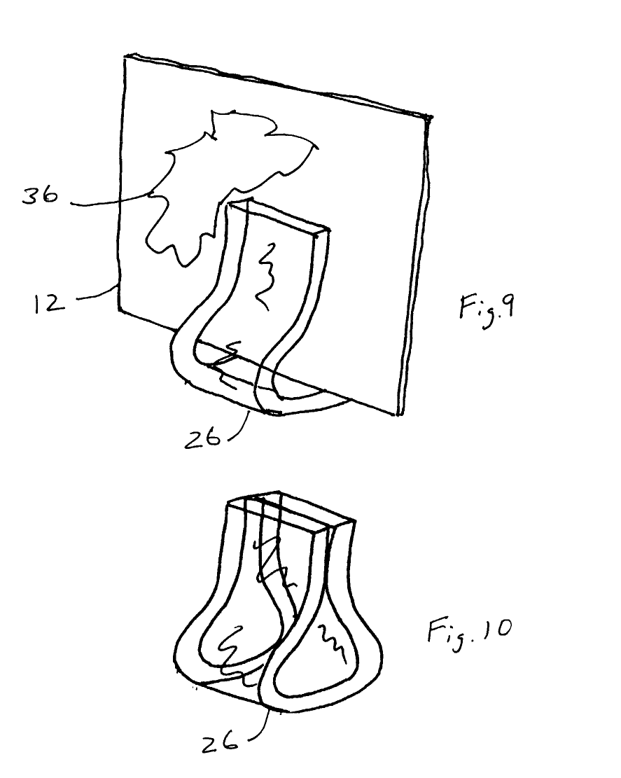

8. FIG. 8 is another embodiment of the game board.

9. FIG. 9 is a second embodiment of a game piece holder with a game piece installed.

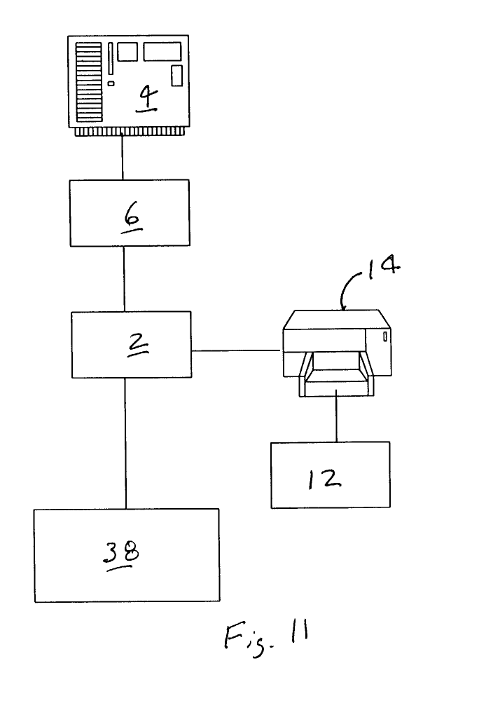

10. FIG. 10 is the second embodiment of the game piece holder.

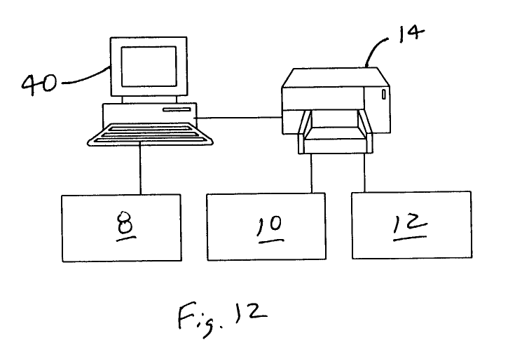

11. FIG. 11 is a block diagram of an additional embodiment.

12. FIG. 12 is a block diagram of an additional embodiment.

### DESCRIPTION OF AN EMBODIMENT

As shown by FIG. 1, a game player uses a client computer 2 to access a server computer 4 over a computer network 6. The computer network 6 may be the Internet. Using the client computer 2, the player requests that the server computer 4 provide playing instructions 8, a playing surface 10 and game pieces 12. The server computer 4 transmits data defining the playing instructions 8, playing surface 10 and game pieces 12 to the client computer 2 over the computer network 6. The client computer 2 displays the playing instructions 8 to the player. The player directs the client computer 2 to instruct a computer printer 14 to print the playing surface 10 and game pieces 12.

The playing surface 10 may be printed on any suitable substrate, such as paper, or provided by any suitable graphical display medium. To accommodate game play on areas larger than a single sheet of paper, the playing surface 10 may be comprised of several sheets which together comprise a single playing surface 10. When the playing surface 10 is printed, playing surface indicia 16 (FIG. 3) are imparted to the substrate to define a playing surface 10 appropriate to the game.

As illustrated by FIG. 2, a game board 18 is provided. The game board 18 is substantially flat and comprised of a base 20, a substantially transparent cover 22 and a hinge 24. As shown by FIG. 2, the hinge 24 allows the cover 22 to be separated from the base 20 to allow insertion of the playing surface 10. The player lifts the cover 22 and inserts the playing surface 10 between the base 20 and transparent cover 22 so that the playing surface 10 is visible through the transparent cover 22. FIG. 4 is an illustration of a playing surface 10 installed on a game board 18 with the playing surface indicia 16 visible through the transparent cover 22.

Game piece holders 26 also are provided, as shown by FIG. 5. The game piece holder 26 is adapted to receive a game piece 12. The player places the game piece 12 into appropriate receptacles 28 of the game piece holders 26. In the embodiment shown by FIG. 5, the receptacle 28 is a simple depression in the surface of the game piece holder 26.

Depending on the rules of the particular game involved, game pieces 12 printed by a computer printer 14 may not be required. Simple tokens may suffice as game pieces 28, such as coins or chess pawns. Game pieces 28 for a particular game may comprise a combination of tokens and game pieces 12 printed by a computer printer 14.

Play of a game is illustrated by FIG. 6. In accord with the playing instruction 8 for the game in question, the player inserts the playing surface 10 into the game board 18 and may place game pieces 12 into game piece holders. Play proceeds according to the play instructions 8, with game pieces 12 being placed or moved on the transparent cover 22 of the game board 18.

The computer system 30, comprising the client computer 2, server computer 4 and computer network 6, may be used either before or during game play to render the game evenly challenging for all players. For example, before the game a player may advise the computer system 30 that certain of the players are children and other of the players are adults. The computer system 30 then may select age and ability-appropriate playing instructions 8 for each player. For example, if the game involves the computer system 30 posing questions to the players, the computer system 30 may ask more difficult questions of an adult and less difficult questions of a child.

As a second example, the computer system 30 may adjust the chances of success for players of different abilities by adjusting the odds (providing a “handicap”). The element of chance provided by dice for many prior art board games may be supplied by the computer system 30 through, say, random number generation. The computer system 30 may adjust the results of such random number generation to favor a player of lesser skill, such as a child, over a player of greater skill, such as an adult.

The computer system 30 also may assess the ability of individual players during game play and adjust on the fly the degree of challenge presented by the game. In the case of, say, a game that asks a player to answer history questions, the computer system 30 may present the player with a question and several possible answers. The player selects one of the answers. If the player answers questions correctly, the computer system 30 may adjust the degree of difficulty of future questions to make the questions more challenging. If the player answers questions incorrectly, the computer system 30 may adjust the difficulty of the questions to make the questions easier to answer.

FIG. 7 and FIG. 8 present alternative embodiments of the game board 18. In FIG. 7, indentations 32 appear in the game board 18 to receive the playing surface 10 directly from a computer printer 14. The indentations 32 secure the playing surface 10 and prevent it from moving during game play. In the embodiment of FIG. 7, no transparent cover 22 is provided and game play occurs directly on the playing surface 10.

FIG. 8 presents an alternative where the transparent cover 22 and base 20 of the game board 18 are comprised of a flexible material, such as vinyl. The flexible transparent layer 22 and base 20 are joined to as to create pockets 34 to receive the playing surface 10. At least one side of the game board 18 is substantially transparent to allow the players to observe the playing surface 10 during play.

FIGS. 9 and 10 present an alternative game piece holder 26 embodiment. The game piece holder 26 may be composed of a clip adapted to hold and support a game piece 12. The alternative game piece holder 12 of FIGS. 9 and 10 is substantially transparent to allow the player to observe the game piece indicia 36. A non-transparent game piece holder 26 also is contemplated by the invention. A game piece holder 26 may carry an identifier, such as a color, and the game piece holder 26 may itself serve as a game piece 12 without a separate game piece 12 being printed by a computer printer 14.

The game piece 12 as printed by the computer printer 14 also may be used without a game piece holder 26.

FIG. 11 is an alternative embodiment of the invention. In the embodiment of FIG. 11, a computer display 38 such as a computer monitor, flat panel display, television, PDA display or other electronic display is substituted for the game board 18 and playing surface 10. The client computer 2 receives playing information 8 from the server computer 4 over the computer network 6. The computer display 38 electronically displays the playing surface 10. The player directs the computer printer 14 to print game pieces 12. The computer display 38 also presents playing instructions 8 to players from the computer system 30. Game play proceeds as described above, with game pieces 12 placed on the playing surface 10 shown by the computer display 38 and as manipulated by the players. Game play is monitored by the computer system 30 using conventional technology, such as touch screen technology. The computer system 30 may adjust the game on the fly based on monitoring by the computer system 30 of game play.

The game apparatus of the present invention may comprise a kit. Such a kit includes a game board 18. Such a kit also may include game pieces 12, game piece holders 26, or a combination of game pieces 12 and game piece holders 26. A kit may include software defining games, game boards and game pieces.

The game apparatus of the present invention may dispense with the computer network 6 and server computer 4. The functions of the server computer 4 and computer network 6 as described above may be served by a stand-alone computer 40, as illustrated by FIG. 12.

Many different embodiments of the above invention are possible. This application is intended to address all possible embodiments and is limited only as described in the following claims.

I claim,

1. A board game apparatus comprising:
a. a game board;
b. a playing surface appearing on said game board;
c. a plurality of game pieces arrayed on said game board such that a plurality of game players may manipulate said game pieces on said game board;
d. a computer system;
e. a plurality of instructions for play displayed by said computer system to said game players.

2. The board game apparatus of claim 1, further comprising:
a. a printer communicating with said computer system;
b. said computer system being programmed to direct said printer to print said playing surface in response to commands by said plurality of game players to said computer system.

3. The board game apparatus of claim 2 further comprising:
a. a plurality of game pieces engaging said game piece holders, said game piece holders being adapted to receive said game pieces;
b. said computer system being programmed to direct said printer to print said game pieces in response to commands by said plurality of game players to said computer system.

4. The board game apparatus of claim 3, said computer system comprising:
a. a server computer;
b. a computer network;
c. a client computer, said client computer being in communication with said server computer through said computer network.

5. The board game apparatus of claim 4, further comprising said plurality of instructions for play being transmitted from said server computer over said computer network to said client computer, said instruction for play being displayed by said client computer to said players.

6. The board game apparatus of claim 5 further comprising data defining said playing surface being transmitted from said server computer over said computer network to said client computer, said playing surface being printed by said printer as directed by said client computer.

7. The board game apparatus of claim 6, further comprising at least one of said plurality of game pieces being transmitted from said server computer over said computer network to said client computer, said at least one of said plurality of game pieces being printed by said printer.

8. The board game apparatus of claim 7, said instructions for play being interactively adjusted based on predetermined criteria to allow for differing ability levels of each of said players.

9. The board game apparatus of claim 8, said computer system monitoring game play while said game is in progress; said interactive adjustment being performed according to predetermined criteria based upon the success of each of said players as monitored by said computer system.

10. A board game apparatus kit for use with a computer system and a playing surface printed from said computer system, said board game apparatus comprising:
a. a game board adapted to receive said playing surface;
b. a plurality of game pieces adapted for playing of a game by a player using said game board.

11. The kit of claim 10 further comprising at least one of said game pieces being printed from said computer system.

12. The kit of claim 11 further comprising a plurality of game piece holders.

13. The kit of claim 10, said computer system comprising a stand-alone computer and a printer, said kit further comprising software for game play, said software adapted to be executed by said computer system.

14. The kit of claim 10, said game board further comprising:
a. a substantially flat base;
b. a substantially transparent cover, said cover being adapted to receive and secure said playing surface between said cover and said base such that said playing surface may be observed through said cover while being supported by said base.

15. The kit of claim 14, said substantially flat base and said transparent cover being formed of flexible materials, said kit further comprising a plurality of pockets defined by a joiner of said flexible cover and flexible base, said plurality of pockets being adapted to receive and secure said playing surface.

16. The kit of claim 10, said game board comprising a base, said base being adapted to receive and to retain said playing surface.

17. A board game apparatus comprising:
a. a computer display;
b. a computer system connected to said computer display and programmed to display a playing surface on said computer display;
c. said computer system being further programmed to display playing instructions to a player;
d. playing pieces adapted to play a game using said playing surface.
